(19) United States
(12) Patent Application Publication
(10) Pub. No.: US 2012/0131740 A1
(43) Pub. Date: May 31, 2012

(54) Toilet Seat Resurfacing Device and Method

(76) Inventor: Thomas Michael Rone, San Diego, CA (US)

(21) Appl. No.: 13/305,772

(22) Filed: Nov. 29, 2011

Related U.S. Application Data
(60) Provisional application No. 61/417,704, filed on Nov. 29, 2010.

(51) Int. Cl. A47K 13/14; B23P 11/00

(52) U.S. Cl. 4/245.3; 4/245.1; 29/428; 297/219.1; 40/320; 297/224

(57) ABSTRACT

A device for resurfacing seats including a reusable seat cover adapted to be utilized multiple times and adapted to be sanitary. A device for resurfacing toilet seats including a seat cover and means for attaching the seat cover to the seat. A method for resurfacing seats including attaching a seat cover to a seat, where the seat cover can be utilized multiple times.

### PRIORITY CLAIM TO U.S. PROVISIONAL

This application claims the benefit of U.S. Provisional Application No. 61/417,704, filed Nov. 29, 2010.

### BACKGROUND OF THE INVENTION

1. Field of Invention

The present invention relates to toilet seats. More particularly it relates to a device and method for making and using resurfaced toilet seats that may have been damaged, vandaliz, has sterility issues, or simply needs to be more aesthetically pleasing, more sanitary, and/or abled to display indicia.

2. Prior Art

The existence of unsanitary public toilets have become a day to day problem that almost everyone encounters, especially when using toilet facilities available to the public. The unsanitary state of the toilet may even cause one to abstain from its use and instead opt to “hold it” until a cleaner facility can be found, such as at home. This of course is not only a nuisance, but abstaining for too long can be painful and even cause permanent damage to internal organs and cause usinesses to lose and also cause business to lose business due to the customer having to leave before desired.

Many attempts have been made to assure customers of the sanitary conditions of the bathroom facilities, such as by having sign-in sheets on display in the bathroom claiming hourly cleaning by a custodian, self cleaning facilities, as well as providing sanitary covers for seats. For Example, U.S. Pat. Nos. 1,643,413 to Mahoney; 3,851,341 to Aoyama; and 4,850,051 to Engel concern folded or foldable seat covers as a barrier between the user and the toilet seat for sanitation purposes. Although providing somewhat of a barrier for the user, they are designed for one-time use only and are discarded afterward. In addition, the one-use paper covered are ruined if they become wet and can become stuck to the seat, which is uncomfortable to the users. Also, the coveres waste a lot of materials, which adds creates financial waste and harm to the environment as well by adding a large amount of waste material.

The presently utilized method are extremely wasteful, especially in highly utilized facilities. Similarly, when a facility offers such amenities and run out, it can be embarrassing or too late if no one is present to ask for them. In cases where no barrier is available for use, one must simply crean the surface themselves by hand or lay down layers of toilet paper by hand. This of course may not accomplish the same sanitary needs as one would get from a barrier. This is because cleaning may not remove germs from ruts or cracks in an underlying layer of the seat since cleaning with Only a wet or damp piece of toilet paper or even a cloth will generally do little to the top surface, and less to internal surfaces. Thereby leaving even more places for bacteria and germs to hide.

In this case replacement of the seat sanitarily be more desirable than other currently available alternatives, but it could be very costly for a large number of toilets. The cost of a seat combined with the cost of labor, makes such an endeavor inefficient and cost prohibitive for larger sets of toilets, such as those large sized public facilities, such as large commercial and government building.

U.S. Pat. Nos. 5,112,431 to Rohde and 4,998,297 to Summerville teach replaceable toilet seat covers for temporary sanitary needs. However, these as well as similar prior art do not offer as similar products on the market art do not offer a permanent. solutions for extended sanitary needs as desired for high traffic restrooms. As such, there is a continuing unmet need for an improved device and system of easily engaged components, which will provide a means to permanently or removably attaching a cleanable and resilient surface to a toilet seat. Such a device should be easily installed to minimize labor but formed of substantially rugged material to survive the environment. Further, it would be preferred in many instances if the installed device displayed indicia for means of advertisement whereby the advertisers may cover the cost of the adding of the covers.

### SUMMARY OF THE INVENTION

The device and method herein disclosed and described achieves the above-mentioned goals through the use of an easily engaged covering, such as plastic polymer film. The device may be engaged to the surface of a seat by one or a combination of the following, shrink film, elastic bands attached to the cover, by elastic properties of the film materials itself, electrostatic adhesion and/or any type of adhesive or the like.

Once engaged, the device herein provides a means to resurface an existing toilet seat with the a newer, more sanitary, more comfortable and more aesthetically pleasing surface. In furtherance of rendering the surface sanitary over time, the film may be impregnated with an antimicrobial or antibacterial substance to ensure sanitary conditions, or may have layers of additional materials or coating in order to improve maintenance of sterility, etc. In order to improve the easy maintenance of the sanitary properties, the plastic polymer is preferably easily cleanable and is non-porous unlike most wooden and synthetic wood toilet seats. Further, the plastic polymer or other suitable material may be clear, colored, or display some indicia to assure that no particles are remaining on the seat after cleaning.

With respect to the above description, before explaining at least one preferred embodiment of the herein disclosed invention in detail, it is to be understood that the invention is not limited in its application to the details of construction and to the arrangement of the components in the following description of illustrated in the drawings. The invention herein described is capable of other embodiments and of being practiced and carried out in various ways which will be obvious to those skilled in the art. Also, it should be understood that the phraseology and terminology employed here in are for the purpose of description and should not be regarded as limiting.

As such, those skilled in the art will appreciate that the conception upon which this disclosure is based may readily be utilized as a basis for designing of other structures, methods and systems for carrying out the several purpose of the present disclosed device. It is important, therefore, that the claims be regarded as including such equivalent construction and methodology insofar as they do not depart from the spirit and scope of the present invention.

It is an object of this invention to provide a device and method to more easily and e resurface a seat, such as a toilet seat through the provision of sheets engaged to the surface of the seat (e.g, shrink material, polymer or co-polymers, multilayer or composite materials, or the like) which will engage and resurface a seat.

It is another object of this invention to provide a sanitary and cleanable surface once engaged to a seat, such as a toilet seat.

It is still another object of the current invention to provide a means of displaying indicia, such as a message, advertisement, warning, insignia, instruction or entertainment (e.g., cartoon) through the placement of indicia on the one or more visible surfaces of the cover while still providing a sanitary surface.

### BRIEF DESCRIPTION OF DRAWING FIGURES

FIG. 1 shows a top view of an embodiment of the claimed device.

FIG. 2 shows a top view of an embodiment of the claimed device.

FIG. 3 shows a side view of an embodiment of the claimed device.

FIG. 4 shows a perspective view of an embodiment of the claimed device.

FIG. 5 shows a perspective view of an embodiment of the claimed device.

FIG. 6 shows a top view of an embodiment of the claimed device.

FIG. 7 shows a top view of an embodiment of the claimed device.

FIG. 8 shows a perspective view of an embodiment of the claimed device.

### DETAILED DESCRIPTION AND THE PREFERRED EMBODIMENTS OF THE INVENTION

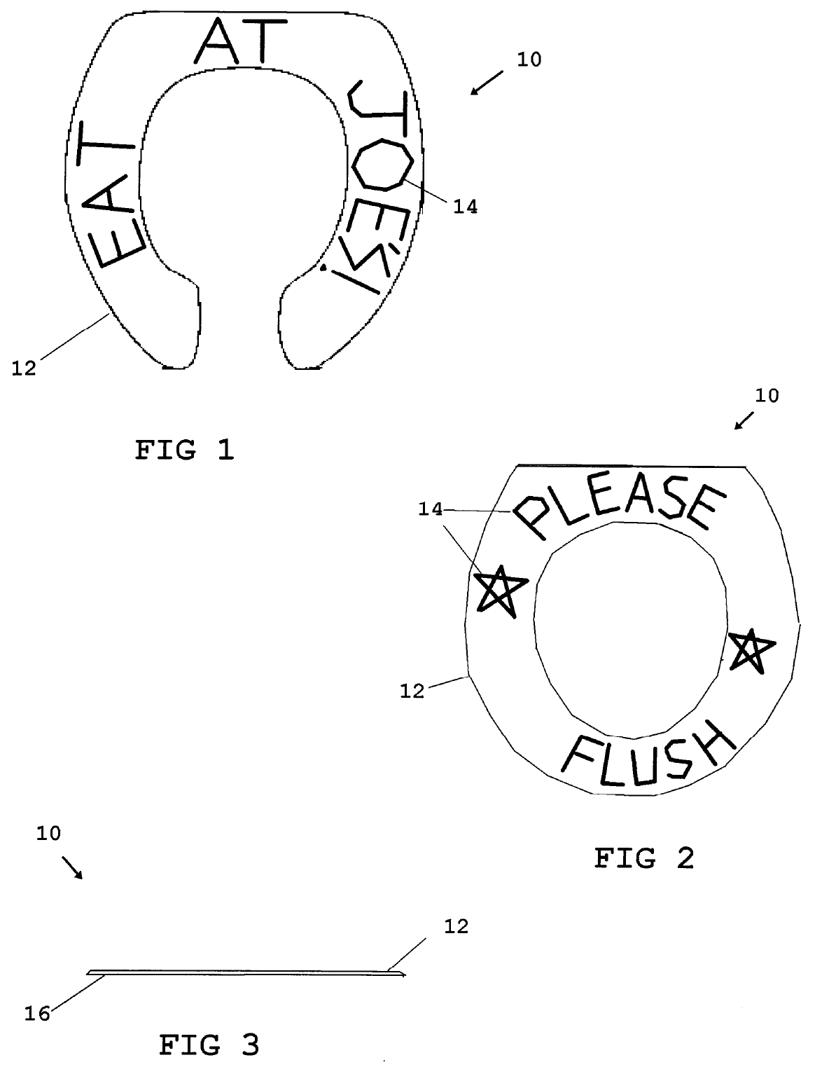

Now referring to drawings in FIGS. 1-8, wherein similar components are identified by like reference numerals, there is seen in FIG. 1 a first embodiment of the device 10 depicted as a single sheet of thin polymer film 12 in the size and shape to fit a toilet seat. Such sizes and shapes tend to be standardized and consequently the device may be pre-configured in or a plurality of shapes and sizes to allow users to order and install device 10 substantially configured in shape and size to their needs. Other possible applications of this invention are any frequently used seating facility, such as park benches, restaurant seats, bars tools, restaurant booths, etc.

While ideally the film is a polymer film, and the polymer chosen inherently resists infestation by bacteria and the like to due to its smooth surface and tight molecular bonding, in an especially preferred mode of the device 10, the film 12 be impregnated with an antimicrobial and/or antibacterial substrate to ensure sanitary conditions. The impregnated agents may be released slowly over time to increase the sanitary lifespan of the product.

FIG. 1 depicts the device 10 configured for an open front style toilet seat while FIG. 2 shows a conventional oval seat. The top surface of the device 10 may display indicia 14 such as lettering, graphics, or combinations thereof (e.g, a trademark, slogan, warning, or indicators when the cover was installed or needs replacing).

The bottom surface may employ adhesive 16 to engage to the surface of a toifet seat might be employed if the device 10 were to be temporary and disposable. Similarly electrostatic adhesion may work in combination with, or instead of, a pressure sensitive adhesive to allow for a centering of the device 10 and then adhesion through application of pressure thereto.

A side view showing the substantially thin is seen in FIG. 3. As shown in this mode, the device 10 is simply placed over the existing toilet seal and pressed firmly allowing the adhesive or the like to set before use.

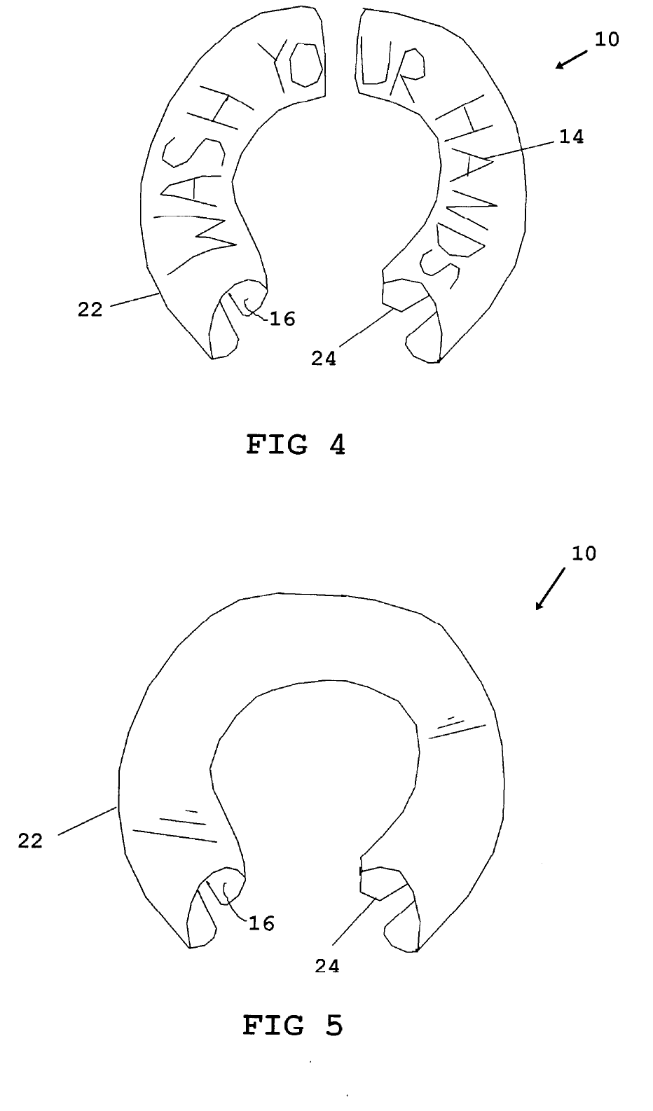

A second mode of the device 10 is seen in FIG. 4. The depiction in the figure consists of two segments of thin shrink film 22 shaped as a discontinuous cylindrical tube leaving a substantial gap 24 along the length of the cylinder. The tubes themselves are arced to conform to the arc of an open front style seat. It may be desired to have two separate elements because hardware used near the rear to secure a seat to the toilet would impede a continuous arc design. However, when such is not the case the device 10 may take on the continuous arc open front style shown in FIG. 5.

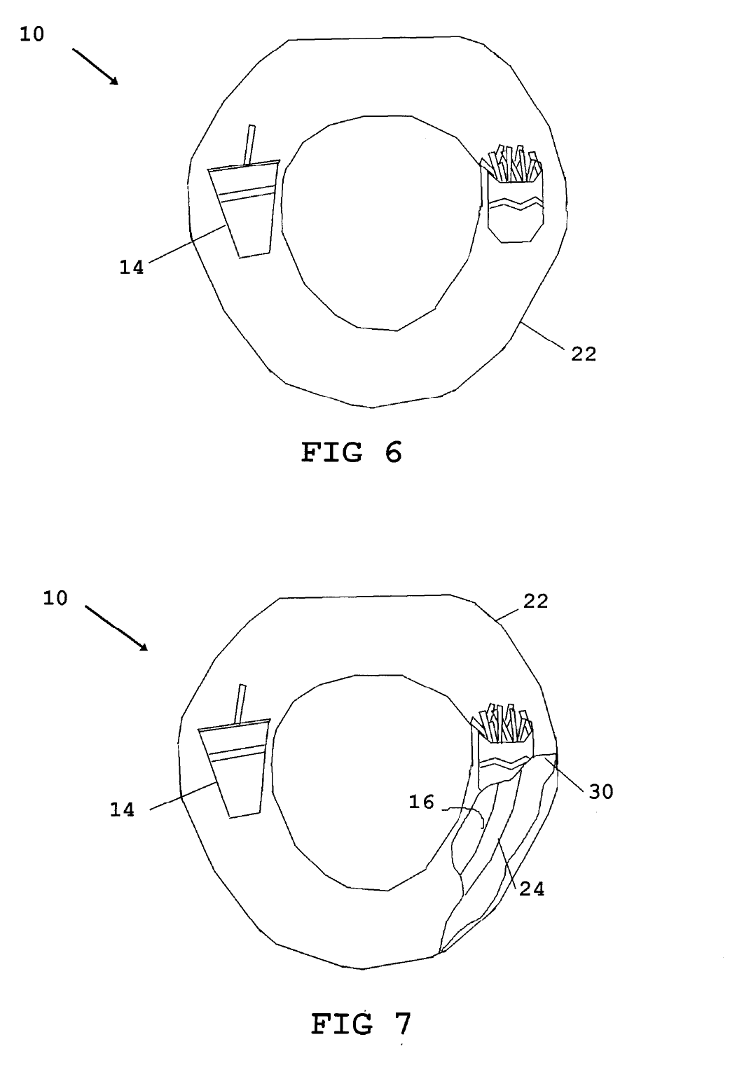

Furthermore, adhesive 15 may be applied to the inner surface of the device prior to shrink wrapping to further ensure proper engagement to the toilet seat surface. This mode allows a user to simply open the gap further and place the device over a seat with adhesive surface down. Heat is then applied as applicable with shrink film adhering it to the seat. Also, adhesive 16 may be applied to the inner surface prior to shrink wrapping to ensure proper fit and adherence. Another embodiment taking the form of an oval type seat can be seen in FIG. 6. A cutaway portion 30 shown in FIG. 7 shows the gap 24 that is formed.

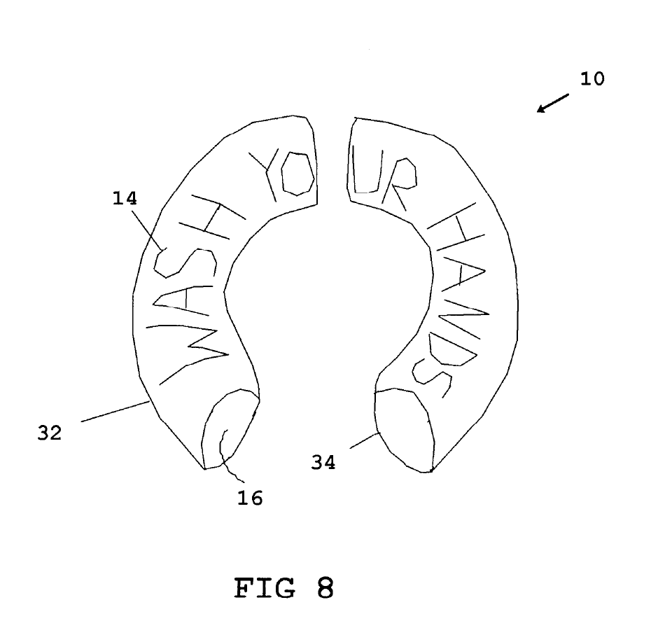

A final mode of the device is seen in FIG. 8 depicted as a a continuous cylindrical tube 34 of thin shrink film 32. This embodiment requires a user to slide the device 10 over the open front portions of a toilet seat. Again, two elements are required due of the obstruction caused from the hardware used to secure the seat to the toilet. As can be discerned by those skilled in the art, this mode of the device would not usually be applicable for the oval style toilet seat. Indicia 14 can be displayed on the outer surface while adhesive 16 may be applied on the inner surface for better adhesion.

Finally, in a method of repairing seats using the device herein, it is anticipated that advertisers would pay to have indicia in the form of product advertising placed on the device 10 and thus defray the cost. In that mode, the seller could arrange to install the devices 10 at venues receptive to such for no charge or reduced charges in return for the right to place the advertising indicia. The reseller could also obtain from advertisers in order to offer the discounted or free repair service to the venue accepting it. This would encourage improved hygiene in public venues.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departmening from the spirit or scope of the invention. Consequently, all such modifications and variations and substitutions are included within the scope of the invention as defined by the following claims.

What is claimed is:

1. A device for resurfacing seats comprising: a reusable seat cover adapted to be utilized multiple times and adapted to be sanitary.

2. The device of claim 1, wherein the cover is made at least in part of film or composite material impregnated with an antimicrobial or antibacterial substance.

3. The device of claim 1, wherein the cover is made at least in part of smooth surface and tight molecular bonding.

4. The device of claim 1, wherein the seat cover wherein the cover is made at least in part of plastic.

5. The device of claim 1, wherein the seat cover wherein the cover is made at least in part of polymer film.

6. The device of claim 1, wherein the cover materials is cleanable and non-porous.

7. The device of claim 1, wherein the seat cover is made at least in part of shrink film.

8. The device of claim 1, wherein the seat is a toilet seat.

9. The device of claim 1, wherein the seat is selected from the group consisting of: park benches, restaurant seats, bars tools and booths.

10. The device of claim 1, wherein the seat cover contains indicia.

11. The device of claim 11, wherein the indicia are an advertisement.

12. The device of claim 11, wherein the indicia are indicate when the seat covers need to be replaced.

13. The device of claim 11, wherein the indicia are a warning.

14. The device of claim 1, wherein the seat cover is able to be utilized multiple times.

15. The device of claim 1, wherein the seat cover is secured to the seat by adhesive, elastic bands, electrostatic adhesion, or combinations thereof.

16. The device of claim 16, wherein the seat cover is secured to the seat by adhesive.

17. The device of claim 16, wherein the seat cover is secured to the seat by elastic bands.

18. The device of claim 16, wherein the seat cover is secured to the seat by electrostatic adhesion.

19. A device for resurfacing toilet seats comprising: a seat cover and means for attaching the seat cover to the seat.

20. A method for resurfacing seats comprising: attaching a seat cover to a seat, wherein the seat cover can be utilized multiple times.
